(19) United States
(12) Patent Application Publication
(10) Pub. No.: US 2011/0069772 A1
(43) Pub. Date: Mar. 24, 2011

(54) TRANSMISSION OF MULTICAST BROADCAST SERVICE (MBS) TRAFFIC IN A WIRELESS ENVIRONMENT

(76) Inventors: Sophie VRZIC, Nepean (CA); Robert Novak, Ottawa (CA); Mo-Kan Fong, Ottawa (CA)

(21) Appl. No.: 12/874,844

(22) Filed: Sep. 2, 2010

Related U.S. Application Data
(60) Provisional application No. 12/806,194, filed on Sep. 2, 2009.

(51) Int. Cl. H04B 7/02; H04L 23/02; H04L 27/00

(52) U.S. Cl. 375/261; 375/267; 375/295

(57) ABSTRACT

Multicast broadcast service (MBS) transmission in a multiple-input-multiple-output (MIMO) communication being transmitted using one of three modes, a single-layer mode, a spatial multiplexing (SM) mode and a hierarchical mode. In the hierarchical mode, lower quality data is transmitted over a first MIMO layer and enhancement data is transmitted over a second MIMO layer. A receiving device may only successfully receive the lower quality data or may successfully receive the enhancement data to enhance it with. The transmission scheme used, including the mode used, may be selectable, and may be selected based on feedback.

### CROSS-REFERENCE TO RELATED APPLICATIONS

This application claims the benefit of U.S. provisional patent application No. 61/239,239 filed on Sep. 2, 2009, which is hereby incorporated by reference in its entirety.

This application is a continuation-in-part of the non-provisional application (serial number tbd) resulting from conversion under 37 C.F.R. §1.53(c)(3) of U.S. provisional patent application No. 61/239,239 filed on Sep. 2, 2009, which claims the benefit of U.S. provisional patent application No. 61/094,562 filed on Sep. 5, 2008.

### FIELD OF THE INVENTION

This application relates to wireless communication techniques in general, and more specifically to symbol transmission in a MIMO scheme using Alamouti codes.

### BACKGROUND

The demand for services in which data is delivered via a wireless connection has grown in recent years and is expected to continue to grow. Included are applications in which data is delivered via cellular mobile telephony or other mobile telephony, personal communications systems (PCS) and digital or high definition television (HDTV). Though the demand for these services is growing, the channel bandwidth over which the data may be delivered is limited. Therefore, it is desirable to deliver data at high speeds over this limited bandwidth in an efficient, as well as cost effective, manner.

A known approach for efficiently delivering high speed data over a channel is by using Orthogonal Frequency Division Multiplexing (OFDM). The high-speed data signals are divided into tens or hundreds of lower speed signals that are transmitted in parallel over respective frequencies within a radio frequency (RF) signal that are known as sub-carrier frequencies (“sub-carriers”). The frequency spectra of the sub-carriers overlap so that the spacing between them is minimized. The sub-carriers are also orthogonal to each other so that they are statistically independent and do not create crosstalk or otherwise interfere with each other. As a result, the channel bandwidth is used much more efficiently than in conventional single carrier transmission schemes such as AM/FM (amplitude or frequency modulation).

Space time transmit diversity (STTD) can achieve symbol level diversity which significantly improves link performance. STTD code is said to be ‘perfect’, therefore, in the sense that it achieves full space time coding rate (Space time coding rate=1, also called rate-1), and it is orthogonal. When the number of transmit antennas is more than 2, however, rate-1 orthogonal codes do not exist.

An approach to providing more efficient use of the channel bandwidth is to transmit the data using a base station having multiple antennas and then receive the transmitted data using a remote station having multiple receiving antennas, referred to as Multiple Input-Multiple Output (MIMO). MIMO technologies have been proposed for next generation wireless cellular systems, such as the third generation partnership project (3GPP) standards. Because multiple antennas are deployed in both transmitters and receivers, higher capacity or transmission rates can be achieved.

When using the MIMO systems to transmit packets, if a received packet has an error, the receiver may require re-transmission of the same packet. Systems are known that provide for packet symbols to be mapped differently than the original transmission.

A particular challenge in modern wireless environments lies in efficiently and reliably providing Multicast Broadcast Service (MBS). Previous solutions have many drawbacks. For example, they fail to satisfactorily address zone coverage or to provide a sufficiently robust solution.

Thus a need exists for an improved way to transmit MBS traffic.

### SUMMARY

In accordance with a first broad aspect is provided a method of performing a multicast broadcast service (MBS) transmission in a multiple-input-multiple-output (MIMO) communication. The method comprises transmitting first data over a first MIMO layer, the first data being lower quality data. The method further comprises transmitting second data over a second MIMO layer, the second data being enhancement data for enhancing the lower quality data. The MBS transmission is to be defined at a subscriber station by the result of enhancing the lower quality data with the enhancement data if the first and second data is successfully received, and the MBS transmission is to be defined at the subscriber station by the lower quality data alone if the first data is successfully received and the second data is not.

In accordance with a second broad aspect is provided a method of performing a multicast broadcast service (MBS) transmission in a multiple-input-multiple-output (MIMO) communication. The method comprises transmitting first data over a first MIMO layer, the first data being lower quality data. The method further comprises selecting whether or not to transmit second data over a second MIMO layer, the second data being enhancement data for enhancing the lower quality data. The MBS transmission is to be defined at a subscriber station by the result of enhancing the lower quality data with the enhancement data if the first and second data is successfully received, and the MBS transmission is to be defined at the subscriber station by the lower quality data alone if the first data is successfully received and the second data is not.

In accordance with a third broad aspect is provided a method for transmitting multicast broadcast service (MBS) traffic in a multiple-input-multiple-output (MIMO) communication. The method comprises selecting a transmission format for transmitting MBS data from amongst a plurality of available transmission formats each having a transmission mode. The method further comprises transmitting the MBS traffic using the selected transmission format; The plurality of available transmission format includes at least a one transmission format comprising one of a single-layer mode, a spatial multiplexing (SM) mode and a hierarchical mode and at least another transmission format comprising another one of a single-layer mode, a spatial multiplexing (SM) mode and a hierarchical mode.

Aspects and features of the present application will become apparent to those ordinarily skilled in the art upon review of the following description of specific embodiments of a disclosure in conjunction with the accompanying drawing figures and appendices.

### BRIEF DESCRIPTION OF THE DRAWINGS

Embodiments of the present application will now be described, by way of example only, with reference to the accompanying drawing figures, wherein:

FIG. 1 is a block diagram of a cellular communication system;

FIG. 2 is a block diagram of an example base station that might be used to implement some embodiments of the present 5 application;

FIG. 3 is a block diagram of an example wireless terminal that might be used to implement some embodiments of the present application;

FIG. 4 is a block diagram of an example relay station that might be used to implement some embodiments of the present application;

FIG. 5 is a block diagram of a logical breakdown of an example OFDM transmitter architecture that might be used to implement some embodiments of the present application;

FIG. 6 is a block diagram of a logical breakdown of an example OFDM receiver architecture that might be used to implement some embodiments of the present application;

FIG. 7 is FIG. 1 of IEEE 802.16m-08/003rl, an Example of overall network architecture;

FIG. 8 is FIG. 2 of IEEE 802.16m-08/003rl, a Relay Station in to overall network architecture;

FIG. 9 is FIG. 3 of IEEE 802.16m-08/003rl, a System Reference Model;

FIG. 10 is FIG. 4 of IEEE 802.16m-08/003rl, The IEEE 802.16m Protocol is Structure;

FIG. 11 is FIG. 5 of IEEE 802.16m-08/003r1, The IEEE 802.16m MS/BS Data Plane Processing Flow;

FIG. 12 is FIG. 6 of IEEE 802.16m-08/003rl, The IEEE 802.16m MS/BS Control Plane Processing Flow;

FIG. 13 is FIG. 7 of IEEE 802.16m-08/003rl, Generic protocol architecture to support multicarrier system;

FIG. 14 is a block diagram of a cellular communication system in which supports MBS;

FIG. 15 is a block diagram of a DL subframe comprising an MBS zone; and

FIG. 16 is a block diagram of a DL subframe comprising an MBS zone on which is superposed unicast data.

Like reference numerals are used in different figures to denote similar elements.

### DETAILED DESCRIPTION

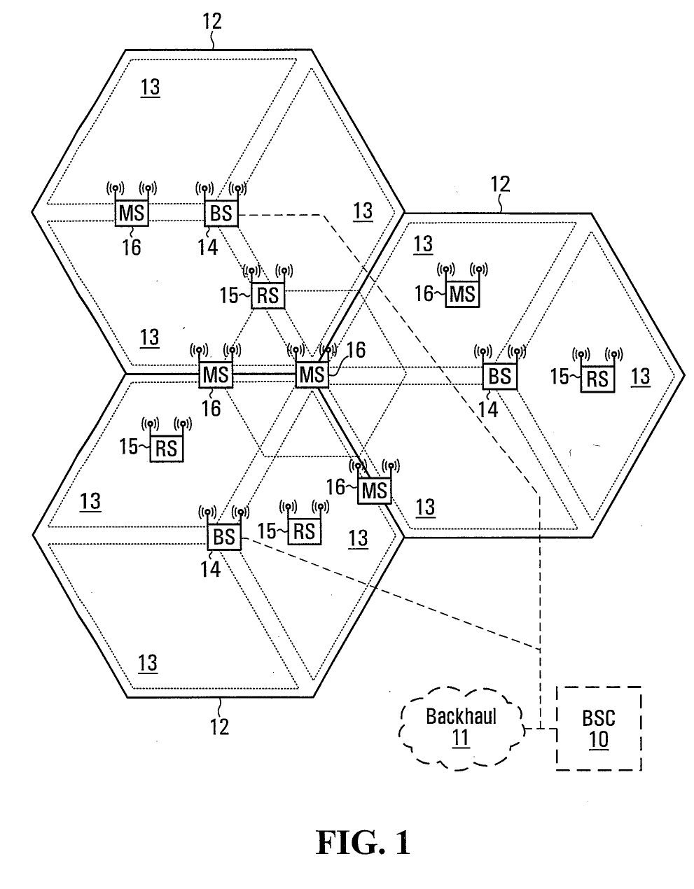

Referring to the drawings, FIG. 1 shows a base station controller (BSC) 10 which controls wireless communications within multiple cells 12, which cells are served by corresponding base stations (BS) 14. In some configurations, each cell is further divided into multiple sectors 13 or zones (not shown). In general, each BS 14 facilitates communications using OFDM with subscriber stations (SS) 16 which can be any entity capable of communicating with the base station, and may include mobile and/or wireless terminals or fixed terminals, which are within the cell 12 associated with the corresponding BS 14. If SSs 16 moves in relation to the BSs 14, this movement results in significant fluctuation in channel conditions. As illustrated, the BSs 14 and SSs 16 may include multiple antennas to provide spatial diversity for communications. In some configurations, relay stations 15 may assist in communications between BSs 14 and wireless terminals 16. SS 16 can be handed off 18 from any cell 12, sector 13, zone (not shown), BS 14 or relay 15 to an other cell 12, sector 13, zone (not shown), BS 14 or relay 15. In some configurations, BSs 14 communicate with each and with another network (such as a core network or the internet, both not shown) over a backhaul network 11. In some configurations, a base station controller 10 is not needed.

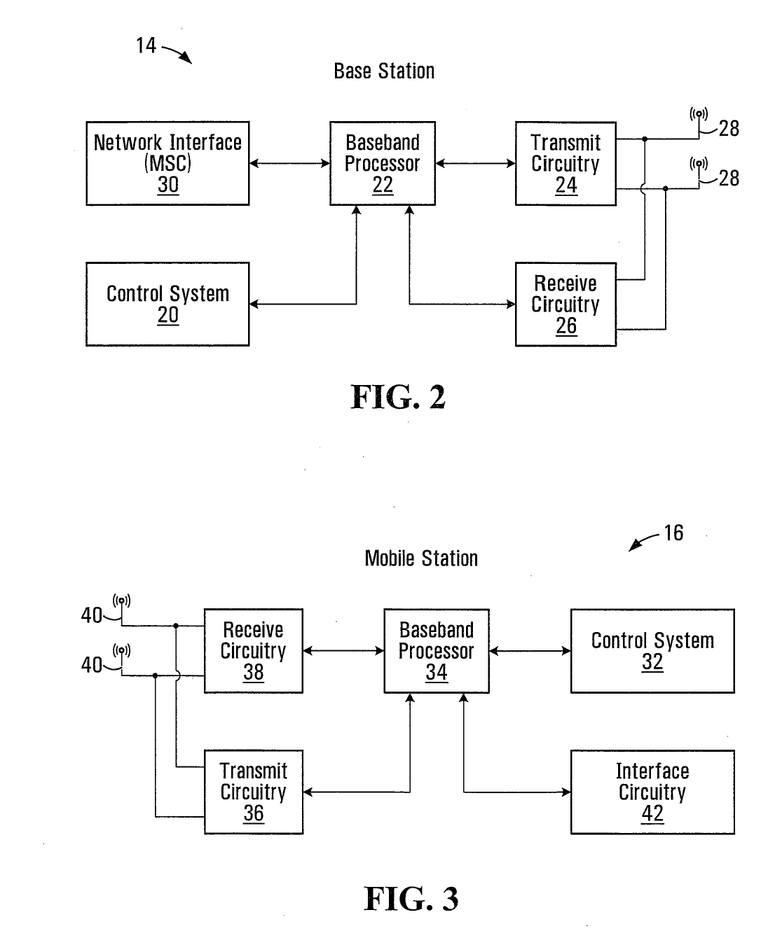

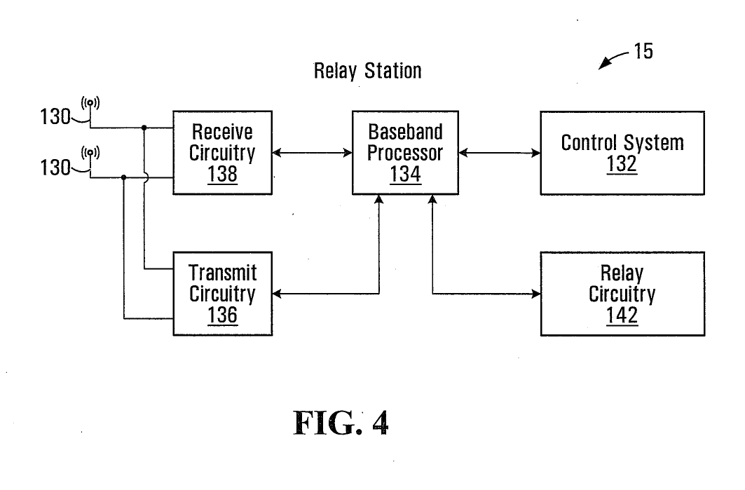

With reference to FIG. 2, an example of a BS 14 is illustrated. The BS 14 generally includes a control system 20, a baseband processor 22, transmit circuitry 24, receive circuitry 26, multiple antennas 28, and a network interface 30. The receive circuitry 26 receives radio frequency signals bearing information from one or more remote transmitters provided by SSs 16 (illustrated in FIG. 3) and relay stations 15 (illustrated in FIG. 4). A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs) or application-specific integrated circuits (ASICs). The received information is then sent across a wireless network via the network interface 30 or transmitted to another SS 16 serviced by the BS 14, either directly or with the assistance of a relay 15.

On the transmit side, the baseband processor 22 receives digitized data, which may represent voice, data, or control information, from the network interface 30 under the control of control system 20, and encodes the data for transmission. The encoded data is output to the transmit circuitry 24, where it is modulated by one or more carrier signals having a desired transmit frequency or frequencies. A power amplifier (not shown) will amplify the modulated carrier signals to a level appropriate for transmission, and deliver the modulated carrier signals to the antennas 28 through a matching network (not shown). Modulation and processing details are described in greater detail below.

With reference to FIG. 3, an example of a subscriber station (SS) 16 is illustrated. SS 16 can be, for example a mobile station. Similarly to the BS 14, the SS 16 will include a control system 32, a baseband processor 34, transmit circuitry 36, receive circuitry 38, multiple antennas 40, and user interface circuitry 42. The receive circuitry 38 receives radio frequency signals bearing information from one or more BSs 14 and relays 15. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 34 processes the digitized received signal to extract the information or data bits conveyed in the received signal. This processing typically comprises demodulation, decoding, and error correction operations. The baseband processor 34 is generally implemented in one or more digital signal processors (DSPs) and application specific integrated circuits (ASICs). For transmission, the baseband processor 34 receives digitized data, which may represent voice, video, data, or control information, from the control system 32, which it encodes for transmission. The encoded data is output to the transmit circuitry 36, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 40 through a matching network (not shown). Various modulation and processing techniques available to those skilled in the art are used for signal transmission between the SS and the base station, either directly or via the relay station.

In OFDM modulation, the transmission band is divided into multiple, orthogonal subcarriers. Each subcarrier is modulated according to the digital data to be transmitted. Because OFDM divides the transmission band into multiple subcarriers, the bandwidth per carrier decreases and the modulation time per carrier increases. Since the multiple subcarriers are transmitted in parallel, the transmission rate for the digital data, or symbols (discussed later), on any given subcarrier is lower than when a single carrier is used.

OFDM modulation utilizes the performance of an Inverse Fast Fourier Transform (IFFT) on the information to be transmitted. For demodulation, the performance of a Fast Fourier Transform (FFT) on the received signal recovers the transmitted information. In practice, the IFFT and FFT are provided by digital signal processing carrying out an Inverse Discrete Fourier Transform (IDFT) and Discrete Fourier Transform (DFT), respectively. Accordingly, the characterizing feature of OFDM modulation is that orthogonal subcarriers are generated for multiple bands within a transmission channel. The modulated signals are digital signals having a relatively low transmission rate and capable of staying within their respective bands. The individual subcarrier are not modulated directly by the digital signals. Instead, all subcarrier are modulated at once by IFFT processing.

In operation, OFDM is preferably used for at least downlink transmission from the BSs 14 to the SSs 16. Each BS 14 is equipped with “n” transmit antennas 28 (n>=1), and each SS 16 is equipped with “m” receive antennas 40 (m>=1). Notably, the respective antennas can be used for reception and transmission using appropriate duplexers or switches and are so labelled only for clarity.

When relay stations 15 are used, OFDM is preferably used for downlink transmission from the BSs 14 to the relays 15 and from relay stations 15 to the SSs 16.

With reference to FIG. 4, an example of a relay station 15 is illustrated. Similarly to the BS 14, and the SS 16, the relay station 15 will include a control system 132, a baseband processor 134, transmit circuitry 136, receive circuitry 138, multiple antennas 130, and relay circuitry 142. The relay circuitry 142 enables the relay 14 to assist in communications between a base station 16 and SSs 16. The receive circuitry 138 receives radio frequency signals bearing information from one or more BSs 14 and SSs 16. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 134 processes the digitized received signal to extract the information or data bits conveyed in the received signal. This processing typically comprises demodulation, decoding, and error correction operations. The baseband processor 134 is generally implemented in one or more digital signal processors (DSPs) and application specific integrated circuits (ASICs).

For transmission, the baseband processor 134 receives digitized data, which may represent voice, video, data, or control information, from the control system 132, which it encodes for transmission. The encoded data is output to the transmit circuitry 136, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 130 through a matching network (not shown). Various modulation and processing techniques available to those skilled in the art are used for signal transmission between the SS and the base station, either directly or indirectly via a relay station, as described above.

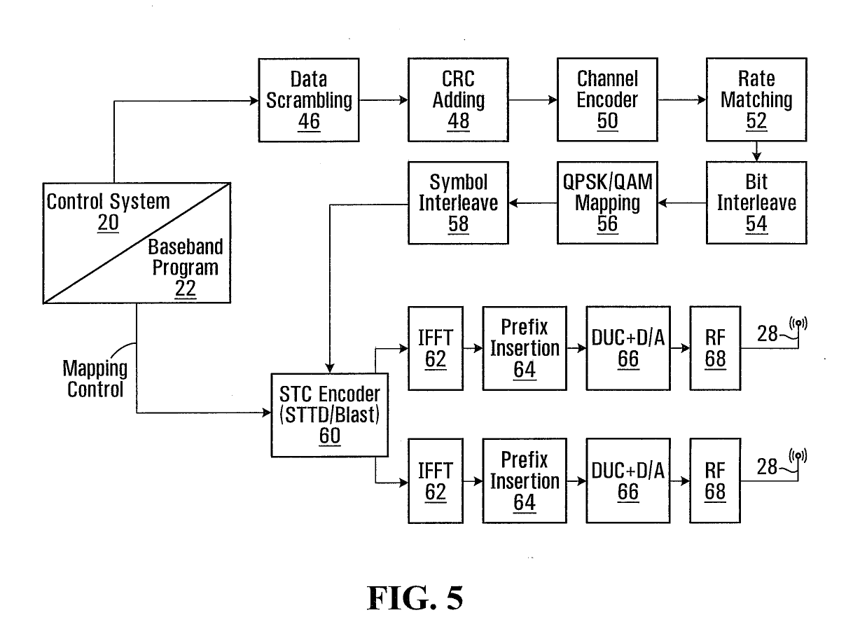

With reference to FIG. 5, a logical OFDM transmission architecture will be described. Initially, the base station controller 10 will send data to be transmitted to various SSs 16 to the BS 14, either directly or with the assistance of a relay station 15. The BS 14 may use the information on the quality of channel associated with the SSs to schedule the data for transmission as well as select appropriate coding and modulation for transmitting the scheduled data. The quality of the channel is found using control signals, as described in more details below. Generally speaking, however, the quality of channel for each SS 16 is a function of the degree to which the channel amplitude (or response) varies across the OFDM frequency band.

Scheduled data 44, which is a stream of bits, is scrambled in a manner reducing the peak-to-average power ratio associated with the data using data scrambling logic 46. A cyclic redundancy check (CRC) for the scrambled data may be determined and appended to the scrambled data using CRC adding logic 48. Next, channel coding is performed using channel encoder logic 50 to effectively add redundancy to the data to facilitate recovery and error correction at the SS 16. Again, the channel coding for a particular SS 16 may be based on the quality of channel. In some implementations, the channel encoder logic 50 uses known Turbo encoding techniques. The encoded data is then processed by rate matching logic 52 to compensate for the data expansion associated with encoding.

Bit interleaver logic 54 systematically reorders the bits in the encoded data to minimize the loss of consecutive data bits. The resultant data bits are systematically mapped into corresponding symbols depending on the modulation scheme chosen by mapping logic 56. The modulation scheme may be, for example, Quadrature Amplitude Modulation (QAM), Quadrature Phase Shift Key (QPSK) or Differential Phase Shift Keying (DPSK) modulation. For transmission data, the degree of modulation may be chosen based on the quality of channel for the particular SS. The symbols may be systematically reordered to further bolster the immunity of the transmitted signal to periodic data loss caused by frequency selective fading using symbol interleaver logic 58.

At this point, groups of bits have been mapped into symbols representing locations in an amplitude and phase constellation. When spatial diversity is desired, blocks of symbols are then processed by space-time block code (STC) encoder logic 60, which modifies the symbols in a fashion making the transmitted signals more resistant to interference and more readily decoded at a SS 16. The STC encoder logic 60 will process the incoming symbols and provide “n” outputs corresponding to the number of transmit antennas 28 for the BS 14. The control system 20 and/or baseband processor 22 as described above with respect to FIG. 5 will provide a mapping control signal to control STC encoding. At this point, assume the symbols for the “n” outputs are representative of the data to be transmitted and capable of being recovered by the SS 16.

For the present example, assume the BS 14 has two antennas 28 (n=2) and the STC encoder logic 60 provides two output streams of symbols. Accordingly, each of the symbol streams output by the STC encoder logic 60 is sent to a corresponding IFFT processor 62, illustrated separately for ease of understanding. Those skilled in the art will recognize that one or more processors may be used to provide such digital signal processing, alone or in combination with other processing described herein. The IFFT processors 62 will preferably operate on the respective symbols to provide an inverse Fourier Transform. The output of the IFFT processors 62 provides symbols in the time domain. The time domain symbols are grouped into frames, which are associated with a prefix by prefix insertion logic 64. Each of the resultant signals is up-converted in the digital domain to an intermediate frequency and converted to an analog signal via the corresponding digital up-conversion (DUC) and digital-to-analog (D/A) conversion circuitry 66. The resultant (analog) signals are then simultaneously modulated at the desired RF frequency, amplified, and transmitted via the RF circuitry 68 and antennas 28. Notably, pilot signals known by the intended SS 16 are scattered among the sub-carriers. The SS 16 may use the pilot signals for channel estimation.

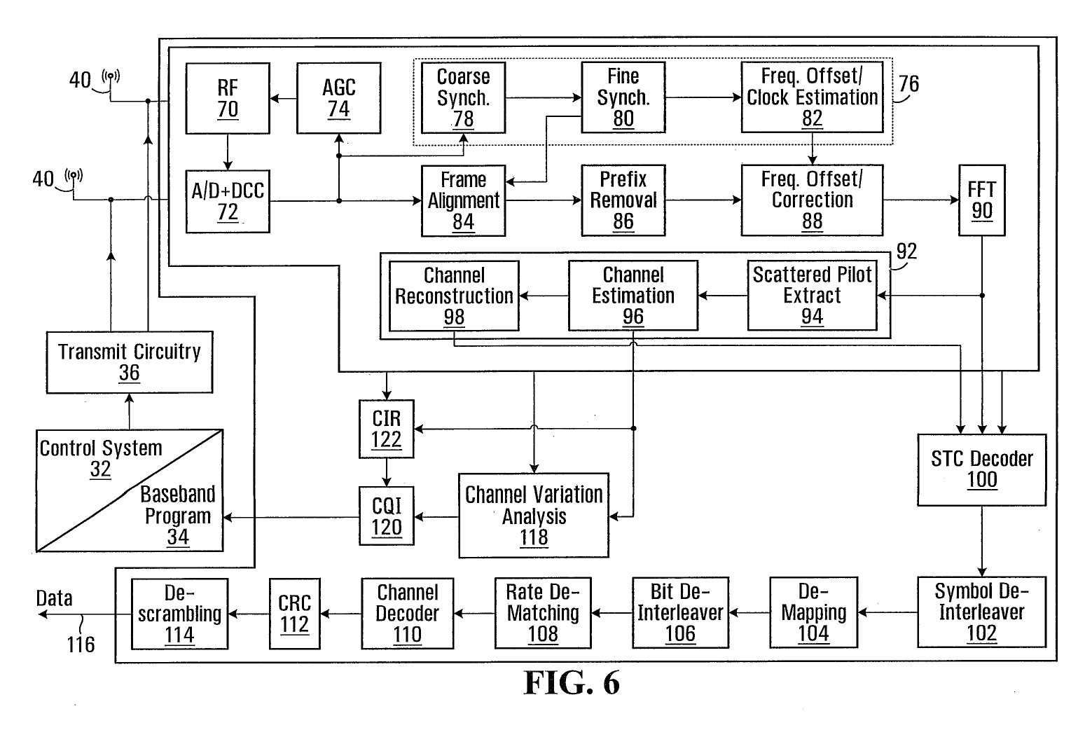

Reference is now made to FIG. 6 to illustrate reception of the transmitted signals by a SS 16, either directly from BS 14 or with the assistance of relay 15. Upon arrival of the transmitted signals at each of the antennas 40 of the SS 16, the respective signals are demodulated and amplified by corresponding RF circuitry 70. For the sake of conciseness and clarity, only one of the two receive paths is described and illustrated in detail. Analog-to-digital (A/D) converter and down-conversion circuitry 72 digitizes and downconverts the analog signal for digital processing. The resultant digitized signal may be used by automatic gain control circuitry (AGC) 74 to control the gain of the amplifiers in the RF circuitry 70 based on the received signal level. Initially, the digitized signal is provided to synchronization logic 76, which includes coarse synchronization logic 78, which buffers several OFDM symbols and calculates an auto-correlation between the two successive OFDM symbols. A resultant time index corresponding to the maximum of the correlation result determines a fine synchronization search window, which is used by fine synchronization logic 80 to determine a precise framing starting position based on the headers. The output of the fine synchronization logic 80 facilitates frame acquisition by frame alignment logic 84. Proper framing alignment is important so that subsequent FFT processing provides an accurate conversion from the time domain to the frequency domain. The fine synchronization algorithm is based on the correlation between the received pilot signals carried by the headers and a local copy of the known pilot data. Once frame alignment acquisition occurs, the prefix of the OFDM symbol is removed with prefix removal logic 86 and resultant samples are sent to frequency offset correction logic 88, which compensates for the system frequency offset caused by the unmatched local oscillators in the transmitter and the receiver. Preferably, the synchronization logic 76 includes frequency offset and clock estimation logic 82, which is based on the headers to help estimate such effects on the transmitted signal and provide those estimations to the correction logic 88 to properly process OFDM symbols.

At this point, the OFDM symbols in the time domain are ready for conversion to the frequency domain using FFT processing logic 90. The results are frequency domain symbols, which are sent to processing logic 92. The processing logic 92 extracts the scattered pilot signal using scattered pilot extraction logic 94, determines a channel estimate based on the extracted pilot signal using channel estimation logic 96, and provides channel responses for all sub-carriers using channel reconstruction logic 98. In order to determine a channel response for each of the sub-carriers, the pilot signal is essentially multiple pilot symbols that are scattered among the data symbols throughout the OFDM sub-carriers in a known pattern in both time and frequency. Continuing with FIG. 6, the processing logic compares the received pilot symbols with the pilot symbols that are expected in certain sub-carriers at certain times to determine a channel response for the sub-carriers in which pilot symbols were transmitted. The results are interpolated to estimate a channel response for most, if not all, of the remaining sub-carriers for which pilot symbols were not provided. The actual and interpolated channel responses are used to estimate an overall channel response, which includes the channel responses for most, if not all, of the sub-carriers in the OFDM channel.

The frequency domain symbols and channel reconstruction information, which are derived from the channel responses for each receive path are provided to an STC decoder 100, which provides STC decoding on both received paths to recover the transmitted symbols. The channel reconstruction information provides equalization information to the STC decoder 100 sufficient to remove the effects of the transmission channel when processing the respective frequency domain symbols.

The recovered symbols are placed back in order using symbol de-interleaver logic 102, which corresponds to the symbol interleaver logic 58 of the transmitter. The de-interleaved symbols are then demodulated or de-mapped to a corresponding bitstream using de-mapping logic 104. The bits are then de-interleaved using bit de-interleaver logic 106, which corresponds to the bit interleaver logic 54 of the transmitter architecture. The de-interleaved bits are then processed by rate de-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for descrambling using the known base station de-scrambling code to recover the originally transmitted data 116.

In parallel to recovering the data 116, a CQI signal comprising an indication of channel quality, or at least information sufficient to derive some knowledge of channel quality at the BS 14, is determined and transmitted to the BS 14. transmission of the CQI signal will be described in more detail below. As noted above, the CQI may be a function of the carrier-to-interference ratio (CR), as well as the degree to which the channel response varies across the various sub-carriers in the OFDM frequency band. For example, the channel gain for each sub-carrier in the OFDM frequency band being used to transmit information may be compared relative to one another to determine the degree to which the channel gain varies across the OFDM frequency band. Although numerous techniques are available to measure the degree of variation, one technique is to calculate the standard deviation of the channel gain for each sub-carrier throughout the OFDM frequency band being used to transmit data. In some embodiments, a relay station may operate in a time division manner using only one radio, or alternatively include multiple radios.

FIGS. 1 to 6 provide one specific example of a communication system that could be used to implement embodiments of the application. It is to be understood that embodiments of the application can be implemented with communications systems having architectures that are different than the specific example, but that operate in a manner consistent with the implementation of the embodiments as described herein.

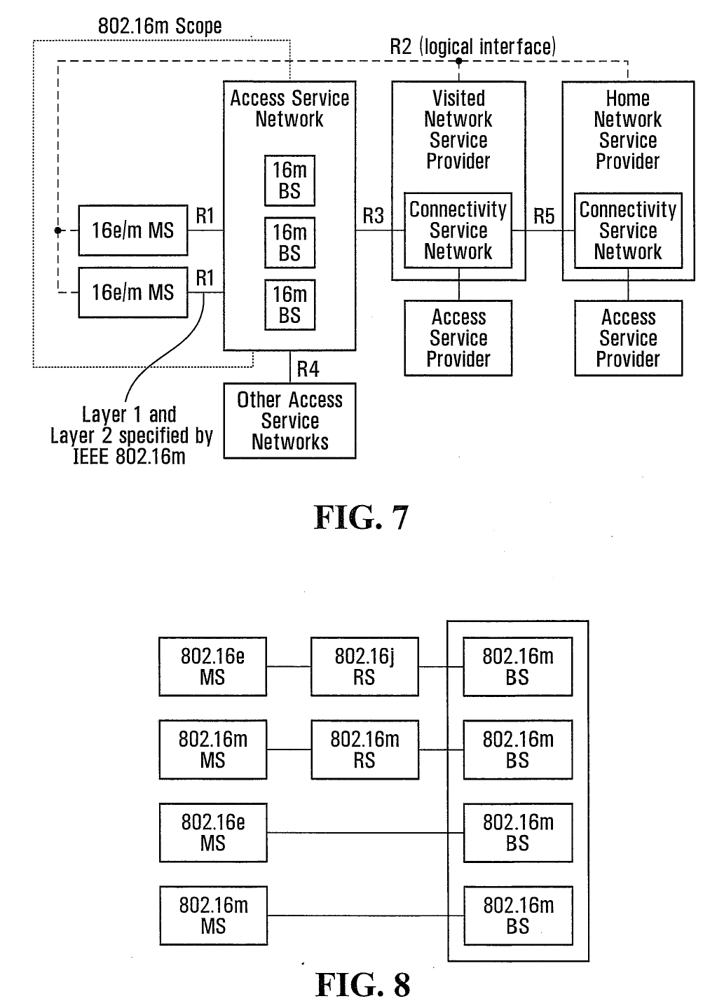

Turning now to FIG. 7, there is shown an example network reference model, which is a logical representation of a network that supports wireless communications among the aforementioned BSs 14, SSs 16 and relay sations (RSs) 15, in accordance with a non-limiting embodiment of the present invention. The network reference model identifies functional entities and reference points over which interoperability is achieved between these functional entities. Specifically, the network reference model can include an SS 16, an Access Service Network (ASN), and a Connectivity Service Network (CSN).

The ASN can be defined as a complete set of network functions needed to provide radio access to a subscriber (e.g., an IEEE 802.16e/m subscriber). The ASN can comprise network elements such as one or more BSs 14, and one or more ASN gateways. An ASN may be shared by more than one CSN. The ASN can provide the following functions:
Layer-1 and Layer-2 connectivity with the SS 16;
Transfer of AAA messages to subscriber's Home Network Service Provider (H-NSP) for authentication, authorization and session accounting for subscriber sessions
Network discovery and selection of the subscriber's preferred NSP;
Relay functionality for establishing Layer-3 (L3) connectivity with the SS 16 (e.g., IP address allocation);
Radio resource management.

In addition to the above functions, for a portable and mobile environment, an ASN can further support the following functions:
ASN anchored mobility;
CSN anchored mobility;
Paging;
ASN-CSN tunneling.

For its part, the CSN can be defined as a set of network functions that provide IP connectivity services to the subscriber. A CSN may provide the following functions:
MS IP address and endpoint parameter allocation for user sessions;
AAA proxy or server;
Policy and Admission Control based on user subscription profiles;
ASN-CSN tunneling support;
Subscriber billing and inter-operator settlement;
Inter-CSN tunneling for roaming;
Inter-ASN mobility.

The CSN can provide services such as location based services, connectivity for peer-to-peer services, provisioning, authorization and/or connectivity to IP multimedia services. The CSN may further comprise network elements such as routers, AAA proxy/servers, user databases, and interworking gateway MSs. In the context of IEEE 802.16m, the CSN may be deployed as part of a IEEE 802.16m NSP or as part of an incumbent IEEE 802.16e NSP.

In addition, RSs 15 may be deployed to provide improved coverage and/or capacity. With reference to FIG. 8, a BS 14 that is capable of supporting a legacy RS communicates with the legacy RS in the “legacy zone”. The BS 14 is not required to provide legacy protocol support in the “16m zone”. The relay protocol design could be based on the design of IEEE 802-16j, although it may be different from IEEE 802-16j protocols used in the “legacy zone”.

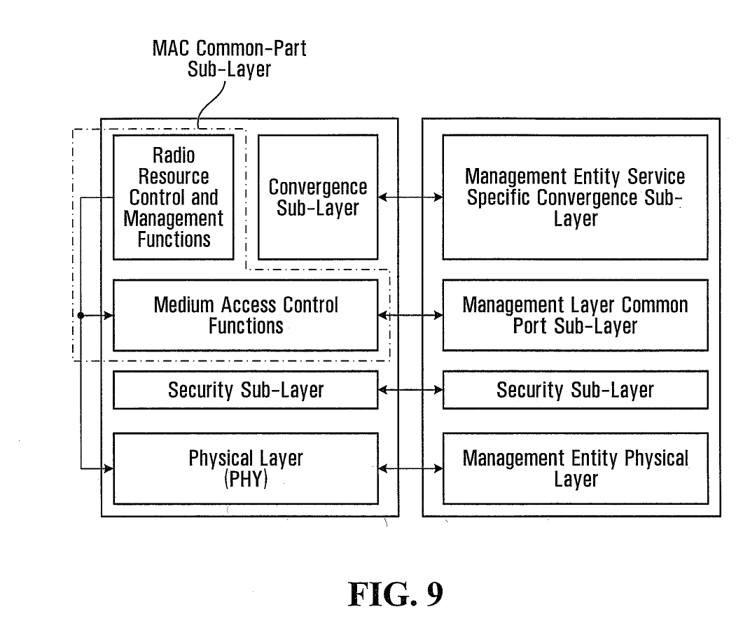

With reference now to FIG. 9, there is shown a system reference model, which applies to both the SS 16 and the BS 14 and includes various functional blocks including a Medium Access Control (MAC) common part sublayer, a convergence sublayer, a security sublayer and a physical (PHY) layer.

The convergence sublayer performs mapping of external network data received through the CS SAP into MAC SDUs received by the MAC CPS through the MAC SAP, classification of external network SDUs and associating them to MAC SFID and CID, Payload header suppression/compression (PHS).

The security sublayer performs authentication and secure key exchange and Encryption.

The physical layer performs Physical layer protocol and functions.

The MAC common part sublayer is now described in greater detail. Firstly, it will be appreciated that Medium Access Control (MAC) is connection-oriented. That is to say, for the purposes of mapping to services on the SS 16 and associating varying levels of QoS, data communications are carried out in the context of “connections”. In particular, “service flows” may be provisioned when the SS 16 is installed in the system. Shortly after registration of the SS 16, connections are associated with these service flows (one connection per service flow) to provide a reference against which to request bandwidth. Additionally, new connections may be established when a customer's service needs change. A connection defines both the mapping between peer convergence processes that utilize the MAC and a service flow. The service flow defines the QoS parameters for the MAC protocol data units (PDUs) that are exchanged on the connection. Thus, service flows are integral to the bandwidth allocation process. Specifically, the SS 16 requests uplink bandwidth on a per connection basis (implicitly identifying the service flow). Bandwidth can be granted by the BS to a MS as an aggregate of grants in response to per connection requests from the MS.

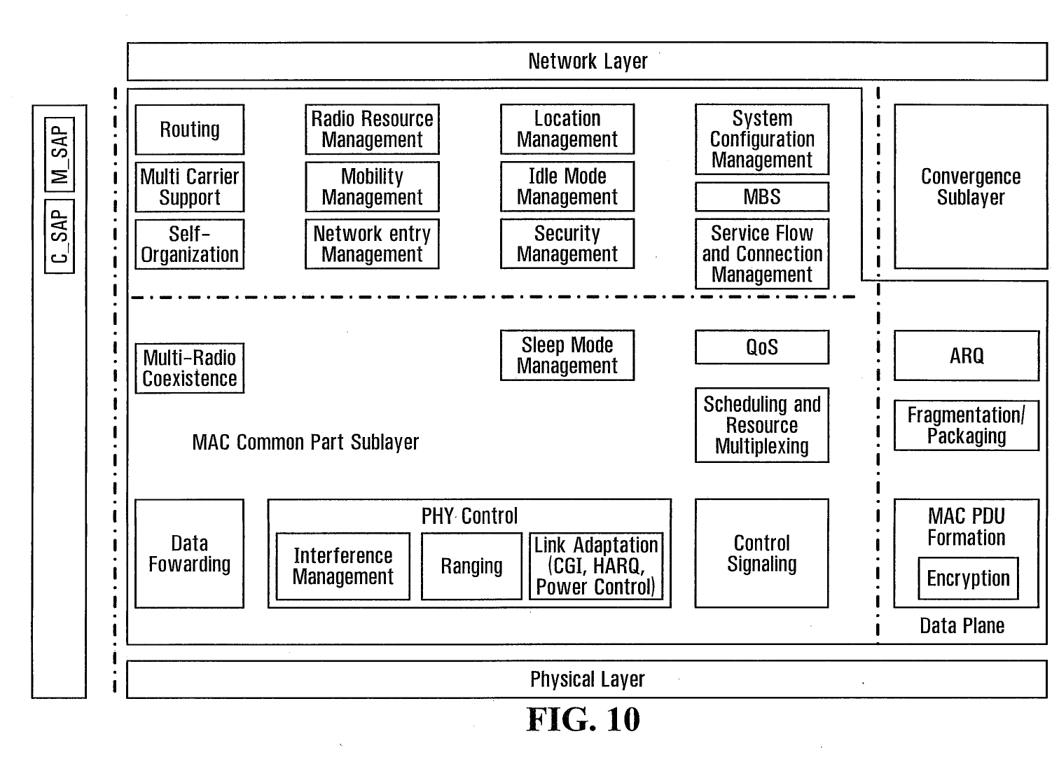

With additional reference to FIG. 10, the MAC common part sublayer (CPS) is classified into radio resource control and management (RRCM) functions and medium access control (MAC) functions.

The RRCM functions include several functional blocks that are related with radio resource functions such as:
Radio Resource Management
Mobility Management
Network Entry Management
Location Management
Idle Mode Management
Security Management
System Configuration Management
MBS (Multicast and Broadcasting Service)
Service Flow and Connection Management
Relay functions
Self Organization
Multi-Carrier

### Radio Resource Management

The Radio Resource Management block adjusts radio network parameters based on traffic load, and also includes function of load control (load balancing), admission control and interference control.

### Mobility Management

The Mobility Management block supports functions related to Intra-RAT/Inter-RAT handover. The Mobility Management block handles the Intra-RAT/Inter-RAT Network topology acquisition which includes the advertisement and measurement, manages candidate neighbor target BSs/RSs and also decides whether the MS performs Intra-RAT/Inter-RAT handover operation.

### Network Entry Management

The Network Entry Management block is in charge of initialization and access procedures. The Network Entry Management block may generate management messages which are needed during access procedures, i.e., ranging, basic capability negotiation, registration, and so on.

### Location Management

The Location Management block is in charge of supporting location based service (LBS). The Location Management block may generate messages including the LBS information.

### Idle Mode Management

The Idle Mode Management block manages location update operation during idle mode. The Idle Mode Management block controls idle mode operation, and generates the paging advertisement message based on paging message from paging controller in the core network side.

### Security Management

The Security Management block is in charge of authentication/authorization and key management for secure communication.

### System Configuration Management

The System Configuration Management block manages system configuration parameters, and system parameters and system configuration information for transmission to the MS.

### MBS (Multicast and Broadcasting Service)

The MBS (Multicast Broadcast Service) block controls management messages and data associated with broadcasting and/or multicasting service.

### Service Flow and Connection Management

The Service Flow and Connection Management block allocates “MS identifiers” (or station identifiers—STIDs) and “flow identifiers” (FIDs) during access/handover/service flow creation procedures. The MS identifiers and FIDs will be discussed further below.

### Relay Functions

The Relay Functions block includes functions to support multi-hop relay mechanisms. The functions include procedures to maintain relay paths is between BS and an access RS.

### Self Organization

The Self Organization block performs functions to support self configuration and self optimization mechanisms. The functions include procedures to request RSs/MSs to report measurements for self configuration and self optimization and receive the measurements from the RSs/MSs.

### Multi-Carrier

The Multi-carrier (MC) block enables a common MAC entity to control a PHY spanning over multiple frequency channels. The channels may be of different bandwidths (e.g. 5, 10 and 20 MHz), be on contiguous or non-contiguous frequency bands. The channels may be of the same or different duplexing modes, e.g. FDD, TDD, or a mix of bidirectional and broadcast only carriers. For contiguous frequency channels, the overlapped guard sub-carriers are aligned in frequency domain in order to be used for data transmission.

The medium access control (MAC) includes function blocks which are related to the physical layer and link controls such as:
PHY Control
Control Signaling
Sleep Mode Management
QoS
Scheduling and Resource Multiplexing
ARQ
Fragmentation/Packing
MAC PDU formation
Multi-Radio Coexistence
Data forwarding
Interference Management
Inter-BS coordination

### PHY Control

The PHY Control block handles PHY signaling such as ranging, measurement/feedback (CQI), and HARQ ACK/NACK. Based on CQI and HARQ ACK/NACK, the PHY Control block estimates channel quality as seen by the MS, and performs link adaptation via adjusting modulation and coding scheme (MCS), and/or power level. In the ranging procedure, PHY control block does uplink synchronization with power adjustment, frequency offset and timing offset estimation.

### Control Signaling

The Control Signaling block generates resource allocation messages.

### Sleep Mode Management

Sleep Mode Management block handles sleep mode operation. The Sleep Mode Management block may also generate MAC signaling related to sleep operation, and may communicate with Scheduling and Resource Multiplexing block in order to operate properly according to sleep period.

### QoS

The QoS block handles QoS management based on QoS parameters input from the Service Flow and Connection Management block for each connection.

### Scheduling and Resource Multiplexing

The Scheduling and Resource Multiplexing block schedules and multiplexes packets based on properties of connections. In order to reflect properties of connections Scheduling and Resource Multiplexing block receives QoS information from The QoS block for each connection.

### ARQ

The ARQ block handles MAC ARQ function. For ARQ-enabled connections, ARQ block logically splits MAC SDU to ARQ blocks, and numbers each logical ARQ block. ARQ block may also generate ARQ management messages such as feedback message (ACK/NACK information).

### Fragmentation/Packing

The Fragmentation/Packing block performs fragmenting or packing MSDUs based on scheduling results from Scheduling and Resource Multiplexing block.

### MAC PDU Formation

The MAC PDU formation block constructs MAC PDU so that BS/MS can transmit user traffic or management messages into PHY channel. MAC PDU formation block adds MAC header and may add sub-headers.

### Multi-Radio Coexistence

The Multi-Radio Coexistence block performs functions to support concurrent operations of IEEE 802.16m and non-IEEE 802.16m radios collocated on the same mobile station.

### Data Forwarding

The Data Forwarding block performs forwarding functions when RSs are present on the path between BS and MS. The Data Forwarding block may cooperate with other blocks such as Scheduling and Resource Multiplexing block and MAC PDU formation block.

### Interference Management

The Interference Management block performs functions to manage the inter-cell/sector interference. The operations may include:
MAC layer operation
Interference measurement/assessment report sent via MAC signaling
Interference mitigation by scheduling and flexible frequency reuse
PHY layer operation
Transmit power control
Interference randomization
Interference cancellation
Interference measurement
Tx beamforming/precoding

### Inter-BS Coordination

The Inter-BS coordination block performs functions to coordinate the actions of multiple BSs by exchanging information, e.g., interference management. The functions include procedures to exchange information for e.g., interference management between the BSs by backbone signaling and by MS MAC messaging. The information may include interference characteristics, e.g. interference measurement results, etc.

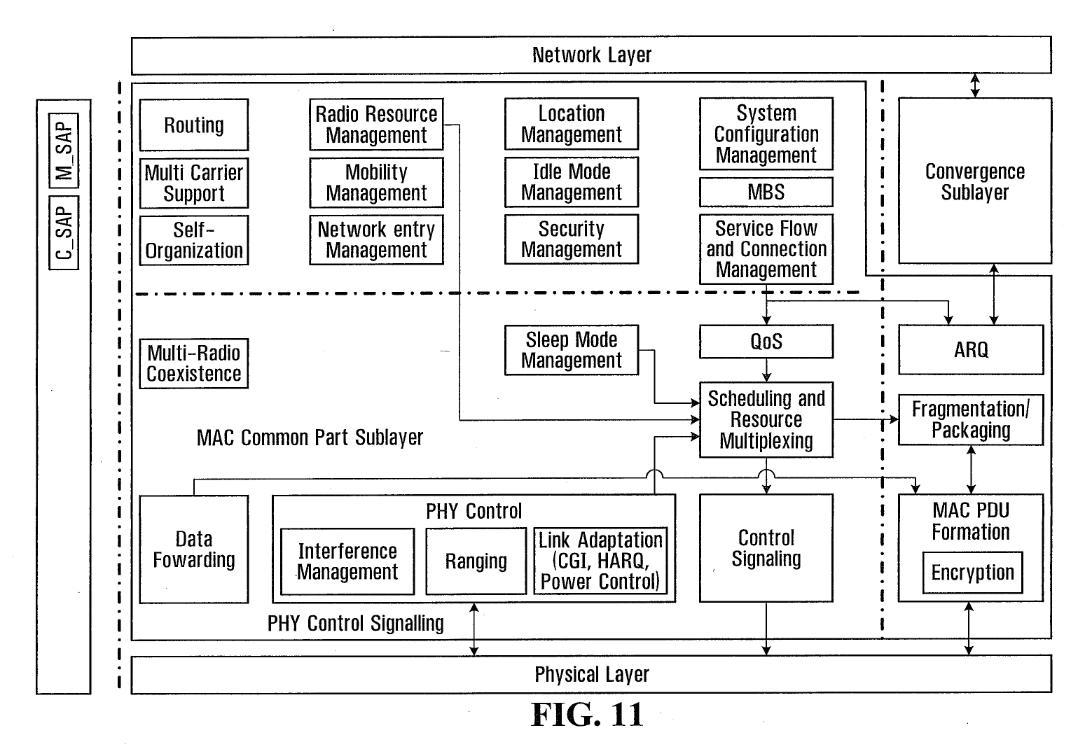

Reference is now made to FIG. 11, which shows the user traffic data flow and processing at the BS 14 and the SS 16. The dashed arrows show the user traffic data flow from the network layer to the physical layer and vice versa. On the transmit side, a network layer packet is processed by the convergence sublayer, the ARQ function (if present), the fragmentation/packing function and the MAC PDU formation function, to form MAC PDU(s) to be sent to the physical layer. On the receive side, a physical layer SDU is processed by MAC PDU formation function, the fragmentation/packing function, the ARQ function (if present) and the convergence sublayer function, to form the network layer packets. The solid arrows show the control primitives among the CPS functions and between the CPS and PHY that are related to the processing of user traffic data.

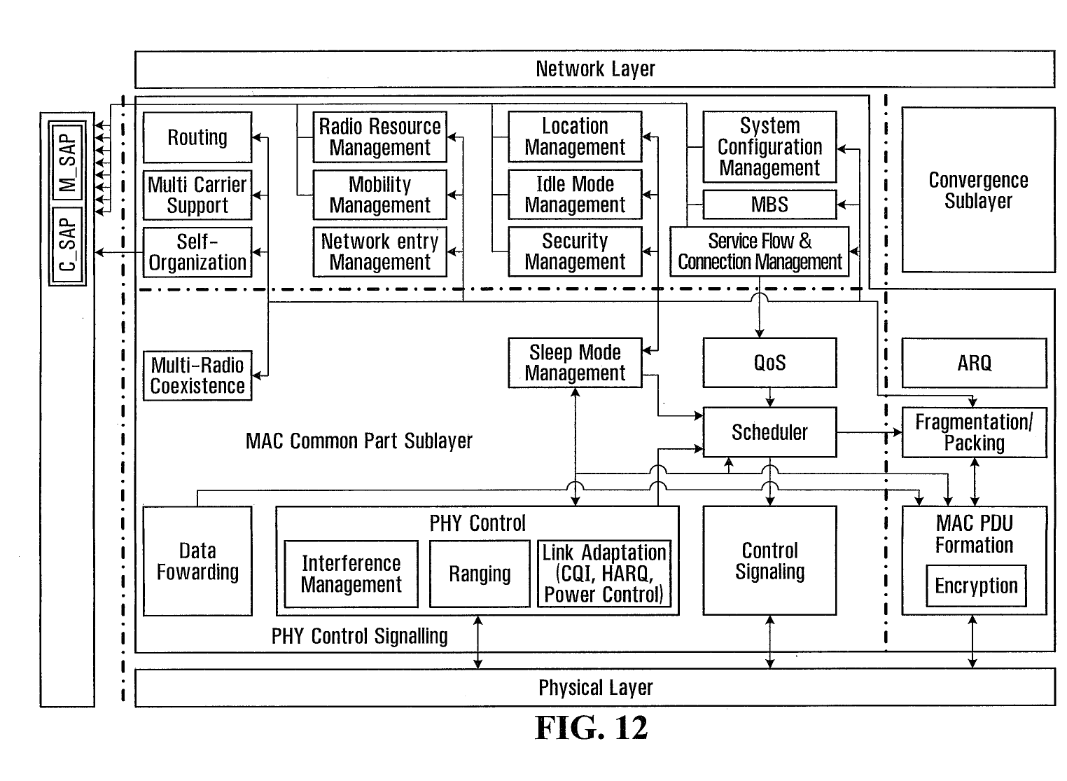

Reference is now made to FIG. 12, which shows the CPS control plane signaling flow and processing at the BS 16 and the MS 14. On the transmit side, the dashed arrows show the flow of control plane signaling from the control plane functions to the data plane functions and the processing of the control plane signaling by the data plane functions to form the corresponding MAC signaling (e.g. MAC management messages, MAC header/sub-header) to be transmitted over the air. On the receive side, the dashed arrows show the processing of the received over-the-air MAC signaling by the data plane functions and the reception of the corresponding control plane signaling by the control plane functions. The solid arrows show the control primitives among the CPS functions and between the CPS and PHY that are related to the processing of control plane signaling. The solid arrows between M_SAP/C_SAP and MAC functional blocks show the control and management primitives to/from Network Control and Management System (NCMS). The primitives to/from M_SAP/C_SAP define the network involved functionalities such as inter-BS interference management, inter/intra RAT mobility management, etc, and management related functionalities such as location management, system configuration etc.

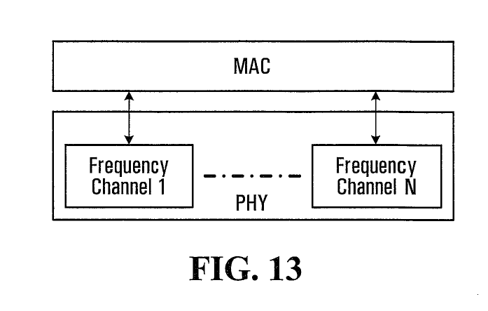

Reference is now made to FIG. 13, which shows a generic protocol architecture to support a multicarrier system. A common MAC entity may control a PHY spanning over multiple frequency channels. Some MAC messages sent on one carrier may also apply to other carriers. The channels may be of different bandwidths (e.g. 5, 10 and 20 MHz), be on contiguous or non-contiguous frequency bands. The channels may be of different duplexing modes, e.g. FDD, TDD, or a mix of bidirectional and broadcast only carriers.

The common MAC entity may support simultaneous presence of MSs 16 with different capabilities, such as operation over one channel at a time only or aggregation across contiguous or non-contiguous channels.

Embodiments of the present invention are described with reference to a MIMO communication system. The MIMO communication system may implement packet re-transmission schemes which may be for use in accordance with the IEEE 802.16(e) and IEEE 802.11 (n) standards. The packet re-transmission schemes described below may be applicable to other wireless environments, such as, but not limited to, those operating in accordance with the third generation partnership project (3GPP) and 3GPP2 standards.

In the following description, the term ‘STC code mapping’ is used to denote a mapping of symbols to antennas. Each symbol in such a mapping may be replaced by its conjugate (e.g. S1*), or a rotation (e.g. jS1, −S1 and −jS1), or a combination of its conjugate and a rotation (e.g. jS1*). In some embodiments, the mapping also includes a signal weighting for each antenna.

Multicasting technique (one-source-many-destination) is widely utilized for multimedia content delivery over networks. Multicast services may be extended using wireless transmission to subscriber stations. In multicast services, a wireless system broadcasts data packets to the subscriber stations and each subscriber station receives and processes the same stream of packets.

MBS may be offered in one direction only, and more particularly in the downlink only. Subscriber stations either in awake/sleep mode or in idle mode may be able to receive the subscribed multicast and broadcast service flows.

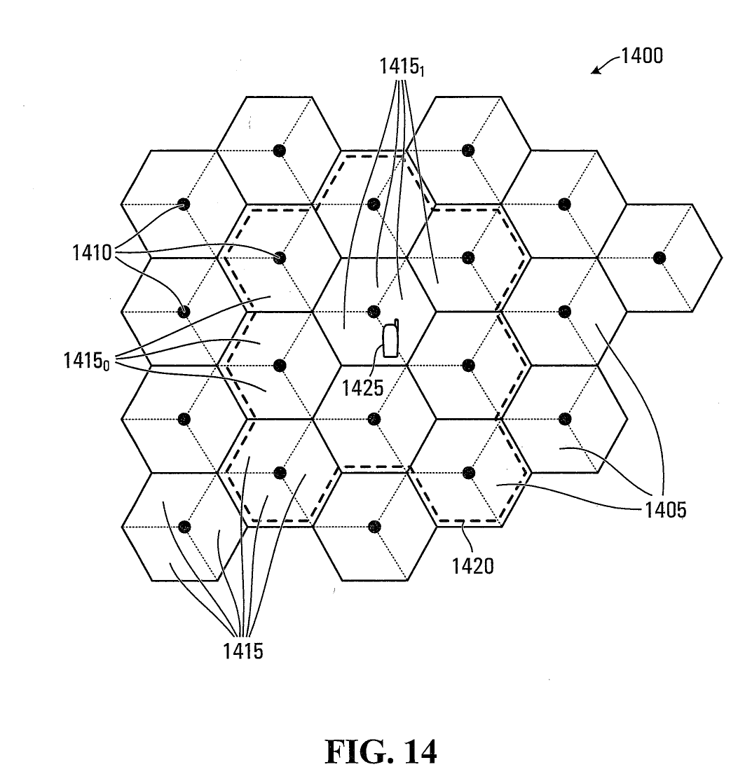

FIG. 14 is a block diagram of an exemplary cellular communication system 1400 a plurality of comprising cells 1405, each cell being served by corresponding BS's 1410. The BS's 1410 and the cells 1405 may be similar to the BS's 14 and cells 12 described above with reference to FIG. 1. As in FIG. 1, in this example, each cell is divided into multiple sectors 1415, although in other embodiments, the cells may not be so divided. The BS's 1410 facilitate communications using OFDM with subscriber stations (SS) 1425 which may be similar to the SS's 16 described above, with reference to FIG. 1 but more generally may be any entity capable of communicating with the base station. In this example, the SS's 1425 are subscribed to MBS or more generally of receive MBS data from the BS's 1410.

The cellular communication system 1400 comprises an MBS area 1420 in which MBS is provided in accordance with a certain MBS scheme. In the present example, MBS transmissions are a single frequency network (SFN) transmissions.

It is to be understood that the size (including number of cells 1405 and sectors 1415 and the shape and relative size of cells 1405 and of sectors 1415) and shape of the cellular communication system 1400, including the MBS area 1420 is purely exemplary and that in other examples, the cellular communication system 1400 may be different. For example, the MBS area 1420 may span the entire cellular communication system 1400, may be as small as only one or a few cells 1405. Furthermore, insofar as the herein description of the MBS area 1420 and MBS schemes used therein can be applied to a single sectors 1415, the MBS area 1420 may span only one or a few sectors 1415.

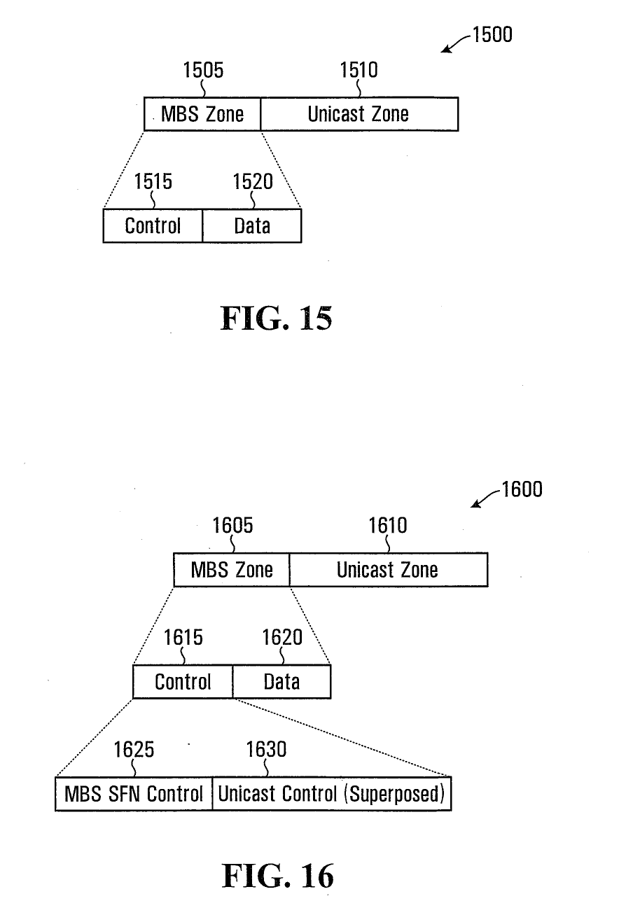

MBS traffic is transmitted downlink from BS 1410 to SS 1425 in DL subframes. More specifically, the MBS traffic is transmitted in a dedicated MBS zone. FIG. 15 shows a DL subframe 1500 comprising an MBS zone 1505 and a unicast zone 1510. In the unicast zone 1510, non-MBS traffic is conveyed in any suitable way. The unicast zone 1510 is so named for the purposes of this example to distinguish it from the MBS zone 1505. However, it is to be understood that the unicast zone 1510 may be any zone in which non MBS data is being transmitted.

The MBS zone comprises MBS traffic, including MBS control information in an MBS control sub-zone 1515 and MBS data in an MBS data sub-zone 1520, as shown.

For simplicity, the DL subframe is shown in block form to illustrate the overall transmission resources occupied by the DL subframe. It is to be understood that the transmission resources occupied by the DL subframe may be defined in any suitable manner, depending on the encoding/modulating scheme used. For example, in an OFDM scheme, the transmission resources assigned to a DL subframe may be defined in terms of time (e.g. time intervals for sending one symbol) and frequency (e.g. subcarriers).

In the present example, the DL subframe 1500 is defined in terms of OFDM intervals and subcarriers. However, it is to be understood that the transmission resources occupied by the DL subframe 1500 may be defined with parameters other than by time and frequency. For example if dedicated frequencies are to be assigned wholly to the downlink, then the DL subframe 1500 may be defined uniquely by frequency. In other examples, the DL subframe 1500 may be defined in terms of time (e.g. OFDM intervals), subcarriers, spreading sequences, or suitable combinations thereof. Indeed, any suitable mode of separating transmissions may be used.

Likewise it is to be understood that the MBS zone 1505 and the unicast zone 1510 may be defined using any suitable parameter type. In the present example the transmission resources occupied by the MBS zone 1505 and by the unicast zone are defined, like the DL subframe 1500 as a whole, in terms of OFDM intervals and subcarriers. However, it should be understood that the transmission resources occupied by these zones may be defined otherwise as well. Furthermore, these zones need not be defined using the same parameters as the DL subframe 1500. For example, they may be defined by particular spreading sequences used for each zone.

In this example, the DL subframe 1500 comprises both an MBS zone 1505 and a unicast zone 1510. These are multiplexed using FDM. It should be understood however, that the MBS zone 1505 could occupy an entire DL subframe.

In the present example, the MBS zone 1505 is a localized zone. That is, it is contiguous in time and frequency. It is to be understood, however, that the MBS zone 1505 may also be a distributed zone that is not contiguous in either time, frequency, or both. A distributed MBS zone may provide more frequency diversity to MBS traffic. In particular, a distributed MBS zone may provide more frequency diversity when the number of sectors participating in SFN transmission is small.

The configuration of the MBS zone and its location (e.g. the transmission resources occupied thereby—in this case time and frequency) can be provided to the SS's 1425 in any suitable way. In one example, the configuration of the MBS zone 1505 may be signaled by the BS. For example, the BS may signal the configuration and location of the MBS zone through any suitable broadcast control, multicast control or unicast control available, to all SS's or just to those who subscribed to the MBS service. In an alternative example, the MBS zone 1505 configurations are agreed to in advance and are not specifically signaled.

The MBS control information contained in the MBS control sub-zone 1515 may contain information on the next occurrence of the MBS zone or data, or on the periodicity of occurrence of the MBS zone or data.

For MBS traffic transmitted for a large network, multipath channel length may be long. To accommodate MBS traffic transmitted for a large network, a larger cyclic prefix size may be defined. In order to enlarge the cyclic prefix size in a DL subframe that is configured to provide for a smaller cyclic prefix size, one OFDM symbol is removed from the DL subframe 1500 containing the MBS zone 1505. The cyclic prefixes of the remaining OFMD symbols are then increased to fill the original subframe duration. It is to be understood that while in this example only one OFDM symbol is removed from the subframe to make space for larger cyclic prefixes, in other examples more symbols may be so removed.

The channelization and pilot pattern for the MBS zone 1505 may be the same across all sectors participating in the SFN transmission. In particular, the pilot used for MBS transmission may be a common pilot that is transmitted on the same tones in every sector participating in the SFN transmissions. Any suitable pilot pattern may be used for MBS tragic. The pilot pattern used for MBS traffic may be the same as that of the unicast pilot pattern or different. In this particular example the MBS pilot pattern is similar to the pilot pattern used for unicast transmissions but with a higher pilot signal density.

As shown in FIG. 15, the MBS control information is contained within the MBS zone 1505. Although the MBS control information is shown here as being in a contiguous MBS control subzone 1515 of the MBS zone 1505, it is to be understood that the MBS control subzone 1515 may be non-contiguous and distributed within the MBS zone 1505.

FIG. 16 shows a DL subframe 1600 comprising an MBS zone 1605 and a unicast zone 1610, similarly to the DL subframe 1500 of FIG. 15. The MBS zone 1605 also comprises an MBS control sub-zone 1615 and an MBS data sub-zone 1620. In this example, unicast data is superposed onto MBS traffic in the MBS zone 1605. In such a case, the unicast control information may be contained within the MBS zone 1605. In particular, the unicast control may be superposed onto the MBS control in the MBS control sub-zone 1615. Thus, as shown, the MBS control sub-zone 1615 may comprise MBS SFN Control 1625 relating to SFN transmission and superposed unicast control information 1630. The unicast control signaling and message format used in the unicast zone may be used to signal the unicast traffic in the MBS zone 1605. It may be used to specify configurations and/or location of the unicast traffic in the MBS zone 1605.

Returning to the example of FIG. 15, in general, common MBS control information may be sent by all sectors 1415 on the same transmission resources within the MBS zone 1505 using SFN transmissions. If some control information is specific to a particular sector 1415, this control information may be broadcast to the SS(s) 1425 in the sector 1415 using transmission resources outside the MBS zone 1505.

The MBS traffic can be transmitted in three different manners. In a first manner, MBS traffic is a single layer transmission. In this case, the same signal is emitted from each of the transmit antennae, e.g. with phase and/or gain weighting to maximize signal power at input. This may be referred to as single layer mode.

In a second case, MBS traffic is transmitted over multiple MIMO layers using spatial multiplexing (SM). This may be referred to as SM mode. In this case, the data may be transmitted using either single codeword (SCW) or multiple codeword (MCW). Generally, however, each sector in the MBS area 1420 or SFN network will transmit all the MIMO layers using the same transmission format.

A third manner of transmitting MBS traffic is to use hierarchical layers. In this hierarchical mode, two or more layers may be transmitted. A first layer is a base layer, which carries lower quality data. In this context, quality of data may refer to a number of things. In one example, the quality data refers to the quality of the electronic product that it defines. For example, the base layer may carry data corresponding to a multimedia product, such as an audio, video or audio-video product having a low quality. For instance, the lower quality data may define a video having a lower bitrate or resolution.

A second layer is an enhanced layer. This layer carries additional information that is complementary to the lower quality data in the form of enhancement data to enhance the quality of the data transmitted at the base layer. The base layer and the enhanced may be for a same MBS transmission. Using the above example, the additional information may carry, information for increasing the bitrate or resolution of the video defined by the lower quality data transmitted over the first layer.

It is to be appreciated that the enhancement data may comprise any data that can enhance the lower quality data. For example, the enhancement data may convey information for adding 3D to 2D movie data being conveyed over the base layer or may comprise data for providing a higher bitrate to audio data being transmitted over the base layer or for providing a higher resolution to image data. The enhancement data may also improve the quality of the lower quality data by providing other enhancements peripheral or supplemental to the lower quality data. For example, the enhancement data may provide closed captioning to video data transmitted over the base layer, or album art and/or song information related to a music audio data transmitted over the enhanced layer.

Furthermore the enhancement data may not be for enhancing the electronic end-product, but rather for enhancing the lower quality data itself, such as by providing additional redundancy.

Beyond the second layer, additional enhancement layers may also be provided to provide further enhancement data to further improve the quality of data transmitted at the base layer. For example, the base layer may carry lower quality data corresponding to a low resolution video data, the enhancement layer may carry enhancement data for improving the quality of the lower quality data, and more specifically for enhancing the resolution of the corresponding video data. A third layer may be provided as a second enhancement layer. This third layer may be further enhancement data for further enhancing the lower quality data. This may be done by applying the further enhancement data to the result of enhancing the lower quality data with the enhancement data. For example, the enhancement data may be for enhancing the resolution of a video defined by the lower quality data and the further enhancement data may be for further enhancing the resolution. Alternatively, the further enhancement data may be applicable directly to the lower quality data, or to both the lower quality data alone or the result of enhancing it with the enhancement data. For instance, the third layer may comprise, for example, closed captioning data, or additional audio data, such as a different language audio track. In such a case, the third layer data can be applied to the lower quality data or to the result of enhancing the lower quality data with the second layer data.

In hierarchical mode, whether or not enhancement data is transmitted, and the transmission configurations and number of layers used may be preset, or may be selectively chosen, or both. For example, each BS may decide how many hierarchical layers to employ, and may additionally be subject to restrictions. In a non-limiting example of a hierarchical mode, there are two possible layers of transmission to use, a base layer as described above and a single enhancement layer. The sectors in the center of the MBS area 1425, such as sectors 14151, may transmit both the base layer and the enhanced layer, while the sectors near or at the edge of the MBS area 1425, such as sectors 14150 may be restricted to transmit only the base layer.

The transmission format used in a transmissions defines the mode (single layer, SM or hierarchical) of transmission of data, as well as the transmission configurations, such as the Modulation Coding Scheme (MCS), which defines the encoding type or rate used and the modulation scheme used. In hierarchical mode, the MCS used for MBS transmission may be different for the different layers. For example, the base layer may employ a more robust MCS to ensure that at least the lower quality data transmitted over the base layer is received by the SS's 1425.

An MCS table may list transmission formats and may comprise any amount on information on the transmission formats listed. In the context of the cellular communications system 1400, the transmission format for the MBS traffic may be indicated by an index into an MBS MCS table. In particular, the MBS MCS table may define, for every MCS index if the transmission is SM or hierarchical. Furthermore, the MBS MCS table may define different modulation levels and code rates to be used, including modulation and code rates to use at various layers, in the case of hierarchical mode. Table 1, below is an exemplary MBS MCS table.

TABLE 1
Exemplary MBS MCS table

| | Level 1 | | Level 2 | | | |
|---|---|---|---|---|---|---|
| MCS | | Code | | Code | Mode (SM/ | |
| Level | Modulation | Rate | Modulation | Rate | Hierarchical) | Field |
| 1 | QPSK | 1/3, | | | | 000 |
| | | 2 reps | | | | |
| 2 | QPSK | 1/3 | | | | 001 |
| 3 | 16 QAM | 1/3 | | | | 010 |
| 4 | 64 QAM | 1/3 | | | | 011 |
| 5 | QPSK | 1/3 | QPSK | 1/3 | H | 100 |
| 6 | QPSK | 1/3 | 16 QAM | 1/3 | H | 101 |
| 7 | QPSK | 1/3 | QPSK | 1/3 | SM | 110 |
| 8 | 16 QAM | 1/3 | 16 QAM | 1/3 | SM | 111 |

Table 1 comprises eight different transmission formats. The MCS level indicates a level of the modulation coding scheme and may be used as an index for identifying a certain transmission format in the table. The Field parameter may also serve to this purpose. The first four such formats define different single-layer modes, each corresponding to a different modulation level and/or code rate. The first format includes QPSK modulation and a code rate of ⅓ with two repetitions. The other three formats include QPSK, 16 QAM and 64 QAM respectively, each with a code rate of ⅓. Since these transmission formats are all single-layer there is no second level for which the table should describe a modulation or encoding scheme

The fifth and sixth transmission formats listed in Table 1 use hierarchical mode. As described above, in this mode a base layer carries lower quality data while an enhanced layer carries enhancement data. As shown, the two layers may, but don't need to, have identical modulation scheme and code rates. In particular in the fifth transmission format listed the base layer and the enhanced layer both use QPSK modulation and a code rate of ⅓. In the sixth transmission format listed the base layer uses QPSK modulation, while the enhanced layer uses 16QAM (both with a code rate of ⅓).

The seventh and eighth transmission formats listed in Table 1 use SM mode. These employ two layers, although the modulation scheme and code rate is the same for both layers.

For hierarchical mode, the selection of the number of hierarchical layers to employ may be made by the BS 1410. The BS 1410 may select the number of hierarchical layers to employ on any suitable basis. In a non-limiting example, the BS 1410 receives feedback from the SS 1425. Feedback is any information indicative of a transmission condition. For example, the feedback may be indicative of a channel condition or quality. Or the feedback may simply be an indication of whether a previous transmission has succeeded or failed. Feedback may also include information on an SS 1425's receiving capabilities or location or any other information that may affect a transmission.

In order to achieve a desired coverage for MBS traffic, the BS 1410 may adapt the transmission format used for SFN transmission based on MBS feedback received from SSs 1425 with which it is in communication.

In general the MBS feedback from the SS 1425 is a low rate feedback indicative of the quality of service of the MBS data. Any suitable feedback scheme may be used and the manner in which the BS 1410 selects a transmission format depends upon the type of feedback received. In one example, the feedback may be a requested transmission format for MBS traffic. Alternatively, the feedback may be in the form of an Acknowledge/No-acknowledge (ACK/NACK) indicator, whereby a NACK may indicate that the MBS Packet Error Rate (PER) exceeds a certain threshold.

In response to such feedback, the BS 1410 may respond by using only a subset of the hierarchical layers. In some instances, the transmission format indicated in the MBS control information may not be consistent with the actual transmission format used by the BS 1410. For example the MBS control information may indicate that hierarchical transmission is being employed but the BS 1410 may only be employing the first layer. This may occur, for example, if the BS 1410 has decided to reduce the number of hierarchical layers being used to achieve a more reliable transmission of the lower quality data. In such a case, although the SS's 1425 receiving the MBS transmissions will not receive (all) the enhancement data, they will still receive the lower quality data over the base layer.

It is to be understood that the MBS MCS table shown above as Table 1 is presented for illustrative purposes only, and in no way is the example of Table 1 intended to be limiting. In particular, it should be noted that an MBS MCS table may comprise more or fewer fields/columns to carry any amount of information regarding the transmission formats contained therein. An MBS MCS table may also, of course, comprise fewer or more transmission formats, depending on the number of such transmission formats available for MBS.

Table 2 shows a simpler example of an MBS MCS table:

TABLE 2
One Level MBS MCS Table

| MCS level | Modulation | Code Rate | Field |
|---|---|---|---|
| 1 | | | 00 |
| 2 | | | 01 |
| 3 | | | 10 |
| 4 | | | 11 |

As shown, in Table 2, no two levels are provided for modulation and code rate. This table may be used for instances where MBS is employ single-layer mode only. Furthermore, in the absence of a mode parameter field to define the mode used for each transmission format listed in the table, it may not be possible to use Table 2 to define a mode (single layer/SM/hierarchical).

Nevertheless, should knowledge that MBS transmission are to take place using the SM mode be obtained from a different source (e.g., if this is a known preset condition for the MBS area), Table 2 may still be used to define the transmission format, if the BS knows that all the layers in the MBS transmission will use the same listed modulation scheme and code rate. Likewise if it is known that the MBS transmission are to take place using a hierarchical mode, Table 2 may also be useful, provided that all layers are to employ the same modulation scheme and code rate, or more generally that no information on additional layers is needed.

Table 3 shows an exemplary MBS MCS table for use with hierarchical mode only.

TABLE 3
Exemplary MBS MCS Table for Hierarchical

| MCS | Level 1 | | Level 2 | | |
|---|---|---|---|---|---|
| Level | Modulation | Code Rate | Modulation | Code Rate | Field |
| 1 | QPSK | 1/3, 2 reps | QPSK | 1/3, 2 reps | 00 |
| 2 | QPSK | 1/3 | QPSK | 1/3 | 01 |
| 3 | QPSK | 1/3, 2 reps | 16 QAM | 1/3, 2 reps | 10 |
| 4 | QPSK | 1/3 | 16 QAM | 1/3 | 11 |

Table 3 is an example of a table that may be used for instance where MBS traffic is transmitted using hierarchical mode only, and does not comprise a mode field. Since every transmission mode listed is implicitly defined as employing hierarchical mode, every transmission mode lists the modulation and code rate used for multiple levels for corresponding layers. In this example, two layers are used in every transmission format. It is to be understood that more layers may be used as well. Furthermore, where multiple layers are used, not all transmission formats need employ all layers.

Table 4 shows an exemplary MBS MCS table combining the single-layer transmission formats shown in Table 2, above, and some of the hierarchical transmission format from Table 3, above. This table thus defines transmission formats defining different modes.

TABLE 4
Exemplary MBS MCS Table Combining Different Modes

| MCS | Level 1 | | Level 2 | | |
|---|---|---|---|---|---|
| Level | Modulation | Code Rate | Modulation | Code Rate | Field |
| 1 | QPSK | 1/3, 2 reps | | | 000 |
| 2 | QPSK | 1/3 | | | 001 |
| 3 | 16QAM | 1/3 | | | 010 |
| 4 | 64QAM | 1/3 | | | 011 |
| 5 | QPSK | 1/3 | QPSK | 1/3 | 100 |
| 6 | QPSK | 1/3 | 16 QAM | 1/3 | 101 |
| 7 | Reserved | | | | 110 |
| 8 | Reserved | | | | 111 |

A similar table could result if the transmission formats include single-layer modes and SM modes. Table 5 shows an exemplary MBS MCS table listing transmission formats that employ both single-layer and SM modes.

TABLE 5
Exemplary MBS MCS Table Combining Different Modes

| | Level 1 | | Level 2 | | | |
|---|---|---|---|---|---|---|
| MCS | | Code | | Code | Mode (SM/ | |
| Level | Modulation | Rate | Modulation | Rate | Hierarchical) | Field |
| 1 | QPSK | 1/3, | | | | 000 |
| | | 2 reps | | | | |
| 2 | QPSK | 1/3 | | | | 001 |
| 3 | 16 QAM | 1/3 | | | | 010 |
| 4 | 64 QAM | 1/3 | | | | 011 |
| 5 | QPSK | 1/3 | QPSK | 1/3 | SM | 100 |
| 6 | 16 QAM | 1/3 | 16 QAM | 1/3 | SM | 101 |
| 7 | Reserved | | | | | 110 |
| 8 | Reserved | | | | | 111 |

Finally, an MBS MCS table may list transmission formats using single layer, SM and hierarchical modes. Table 6 is an example of such an MBS MCS table. As shown, Table 6 includes fields for the modulation and coding at two levels, which fields may have different values if the mode indicated for that particular transmission is the hierarchical mode.

TABLE 6
Exemplary MBS MCS table

| | Level 1 | | Level 2 | | | |
|---|---|---|---|---|---|---|
| MCS | | Code | | Code | Mode (SM/ | |
| Level | Modulation | Rate | Modulation | Rate | Hierarchical) | Field |
| 1 | QPSK | 1/3, | QPSK | 1/3, | H | 000 |
| | | 2 reps | | 2 reps | | |
| 2 | QPSK | 1/3 | QPSK | 1/3 | H | 001 |
| 3 | QPSK | 1/3 | 16 QAM | 1/3 | H | 010 |
| 4 | 16 QAM | 1/3 | | | | 011 |
| 5 | 64 QAM | 1/3 | | | | 100 |
| 6 | QPSK | 1/3 | QPSK | 1/3 | SM | 101 |
| 7 | 16 QAM | 1/3 | 16 QAM | 1/3 | SM | 110 |
| 8 | Reserved | | | | | 111 |

If there are more than one MBS network or areas communicating different MBS transmissions in the cellular communication system 1400, neighboring MBS areas may use non-overlapping MBS zones for the transmission of their respective MBS content. On the resources used by the neighboring MBS network, lower power unicast data may be transmitted.

Furthermore, for the sectors 1415 at the edge of the MBS zone may use additional resources to transmit the MBS traffic. Additional information may be transmitted for chase combining or incremental redundancy as done in HARQ for unicast data. This information may be transmitted within a same sub-frame as the original MBS transmission or in a later sub-frame. This may be done across several sectors using SFN, or independently on a per-sector basis.

The above-described embodiments of the present application are intended to be examples only. Those of skill in the art may effect alterations, modifications and variations to the particular embodiments without departing from the scope of the application.

1. A method of performing a multicast broadcast service (MBS) transmission in a multiple-input-multiple-output (MIMO) communication comprising:
a. transmitting first data over a first MIMO layer, the first data being lower quality data; and
b. transmitting second data over a second MIMO layer, the second data being enhancement data for enhancing the lower quality data;
wherein, the MBS transmission is to be defined at a subscriber station by the result of enhancing the lower quality data with the enhancement data if the first and second data is successfully received, and the MBS transmission is to be defined at the subscriber station by the lower quality data alone if the first data is successfully received and the second data is not.

2. The method of claim 1, wherein the first data is sent over the first MIMO layer using a first encoding scheme and the second data is sent over the second MIMO layer using a second encoding scheme different from the first encoding scheme.

3. The method of claim 2, wherein the first encoding scheme is QPSK and the second encoding scheme is 16 QAM.

4. The method of claim 1, wherein the first data is sent over the first MIMO layer using a first encoding scheme and the second data is sent over the second MIMO layer using a second encoding scheme different from the first encoding scheme.

5. The method of claim 1, further comprising transmitting third data over a third MIMO layer, the third data being further enhancement data for further enhancing the lower quality data.

6. The method of claim 5, wherein further enhancing the lower quality data comprises applying the further enhancement data to the result of enhancing the lower quality data with the enhancement data.

7. A method of performing a multicast broadcast service (MBS) transmission in a multiple-input-multiple-output (MIMO) communication comprising:
a. transmitting first data over a first MIMO layer, the first data being lower quality data; and
b. selecting whether or not to transmit second data over a second MIMO layer, the second data being enhancement data for enhancing the lower quality data;
wherein, the MBS transmission is to be defined at a subscriber station by the result of enhancing the lower quality data with the enhancement data if the first and second data is successfully received, and the MBS transmission is to be defined at the subscriber station by the lower quality data alone if the first data is successfully received and the second data is not.

8. The method of claim 7, further comprising receiving from a subscriber station feedback indicative of a transmission condition, wherein the selecting whether or not to transmit second data is done on basis of the feedback.

9. The method of claim 8, further comprising on the basis of the feedback, selecting whether or not to transmit third data over a second MIMO layer, the third data being further enhancement data for further enhancing the lower quality data.

10. The method of claim 8, wherein the selecting whether or not to transmit second data is done on the basis of a geographical location.

11. The method of claim 9, wherein the selecting whether or not to transmit second data is done on the basis of a proximity to an edge of an area of MBS coverage.

12. A method for transmitting multicast broadcast service (MBS) traffic in a multiple-input-multiple-output (MIMO) communication comprising:
a. selecting a transmission format for transmitting MBS data from amongst a plurality of available transmission formats each having a transmission mode;
b. transmitting the MBS traffic using the selected transmission format;
wherein the plurality of available transmission format includes at least a one transmission format comprising one of a single-layer mode, a spatial multiplexing (SM) mode and a hierarchical mode and at least another transmission format comprising another one of a single-layer mode, a spatial multiplexing (SM) mode and a hierarchical mode.

13. The method of claim 12, wherein the plurality of transmission formats are defined in an MBS modulation coding scheme (MCS) table.

14. The method of claim 12, wherein the plurality of transmission formats include a first transmission format comprising a hierarchical mode.

15. The method of claim 14, wherein the first transmission format further comprises a first modulation and coding scheme for transmitting first data over a first layer and a second modulation and coding scheme for transmitting second data over a second layer, the second data being complementary to the first data.
